(19) United States
(12) Patent Application Publication
(10) Pub. No.: US 2026/0370392 A1
(43) Pub. Date: Nov. 19, 2026

(54) METHOD AND DEVICE FOR SENDING RESPONSE INFORMATION, METHOD AND DEVICE FOR RECEIVING RESPONSE INFORMATION, AND READABLE STORAGE MEDIUM

(71) Applicant: Beijing Xiaomi Mobile Software Co., Ltd., Beijing (CN)

(72) Inventor: Ting FU, Beijing (CN)

(21) Appl. No.: 19/154,282

(22) PCT Filed: Feb. 10, 2023
(86) PCT No.: PCT/CN2023/075510

§ 371 Date: Aug. 6, 2025

(51) Int. Cl. H04L 1/1812; H04L 5/00; H04W 72/0453; H04W 72/11; H04W 72/21; H04W 76/28

(52) U.S. Cl. CPC H04L 1/1812; H04L 5/0044; H04W 72/0453; H04W 72/11; H04W 72/21; H04W 76/28

(57) ABSTRACT

A method for sending response information, including: sending a hybrid automatic repeat request-acknowledgement (HARQ-ACK) to a network device on a first carrier within a first time period, where the HARQ-ACK is configured by the network device or pre-defined by a protocol to be sent on a second carrier, the first time period is located within a third time period of discontinuous reception (DRX) of the second carrier, and the first carrier is different from the second carrier.

### CROSS-REFERENCE TO RELATED APPLICATIONS

The present application is a U.S. National Stage of International Application No. PCT/CN 2023/075510, filed on Feb. 10, 2023, the contents of all of which are incorporated herein by reference in their entireties for all purposes.

### BACKGROUND OF THE INVENTION

A network device can use discontinuous reception (DRX) to save energy consumption. A DRX technology includes two time periods, one of which is referred to as a first time period of DRX and the other of which is referred to as a second time period of the DRX.

### SUMMARY OF THE INVENTION

The present disclosure relates to the technical field of wireless communication, and provides a method and device for sending response information, a method and device for receiving response information, and a readable storage medium.

A first aspect provides a method for sending response information. The method is performed by user equipment. The method includes:
sending a hybrid automatic repeat request acknowledgement (HARQ-ACK) to a network device on a first carrier within a first time period. The HARQ-ACK is configured by the network device or pre-defined by a protocol to be sent on a second carrier. The first time period is located within a third time period of discontinuous reception (DRX) of the second carrier. The first carrier is different from the second carrier.

A second aspect provides a method for receiving response information. The method is performed by a network device. The method includes:
receiving an HARQ-ACK sent by user equipment on a first carrier within a first time period. The HARQ-ACK is configured by the network device or pre-defined by a protocol to be sent on a second carrier. The first time period is located within a third time period of discontinuous reception (DRX) of the second carrier. The first carrier is different from the second carrier.

A third aspect provides an electronic device. The electronic device includes:
one or more processors; and
a memory.

The memory is configured to store a computer program.

The one or more processors are collectively configured to execute the computer program to implement the first aspect or any possible design of the first aspect.

A fourth aspect provides an electronic device. The electronic device includes:
one or more processors; and
a memory.

The memory is configured to store a computer program.

The one or more processors are collectively configured to execute the computer program to implement the second aspect or any possible design of the second aspect.

A fifth aspect provides a non-transitory computer-readable storage medium. The non-transitory computer-readable storage medium stores instructions. The instructions, when invoked and executed in a computer, cause the computer to perform the first aspect or any possible design of the first aspect.

A sixth aspect provides a non-transitory computer-readable storage medium. The non-transitory computer-readable storage medium stores instructions. The instructions, when invoked and executed in a computer, cause the computer to perform the second aspect or any possible design of the second aspect.

### BRIEF DESCRIPTION OF DRAWINGS

The accompanying drawings described here serve to provide further understanding of embodiments of the present disclosure and form part of the present disclosure. Examples in the embodiments of the present disclosure and their description serve to explain the embodiments of the present disclosure and are not to be construed as unduly limiting the embodiments of the present disclosure. In the drawings:

The accompanying drawings here, incorporated in the description as a constituent part of the description, illustrate embodiments conforming to the embodiments of the present disclosure, and serve to describe principles of the embodiments of the present disclosure together with the description.

FIG. 1 is a schematic diagram of a framework of a wireless communication system according to an embodiment of the present disclosure;

FIG. 2 is a schematic diagram of DRX corresponding to different carriers according to an embodiment of the present disclosure;

FIG. 3 is a schematic diagram of DRX corresponding to different carriers according to another embodiment of the present disclosure;

FIG. 4 is a schematic diagram of interaction of sending and receiving response information according to an embodiment of the present disclosure;

FIG. 5 is a schematic diagram of interaction of sending and receiving response information according to another embodiment of the present disclosure;

FIG. 6 is a schematic diagram of interaction of sending and receiving response information according to yet another embodiment of the present disclosure;

FIG. 7 is a schematic diagram of interaction of sending and receiving response information according to yet another embodiment of the present disclosure;

FIG. 8 is a schematic diagram of interaction of sending and receiving response information according to still another embodiment of the present disclosure;

FIG. 9 is a flowchart of sending response information according to an embodiment of the present disclosure;

FIG. 10 is a flowchart of sending response information according to another embodiment of the present disclosure;

FIG. 11 is a flowchart of sending response information according to yet another embodiment of the present disclosure;

FIG. 12 is a flowchart of sending response information according to still another embodiment of the present disclosure;

FIG. 13 is a flowchart of receiving response information according to an embodiment of the present disclosure;

FIG. 14 is a flowchart of receiving response information according to another embodiment of the present disclosure;

FIG. 15 is a flowchart of receiving response information according to yet another embodiment of the present disclosure;

FIG. 16 is a structural diagram of a device for sending response information according to an embodiment of the present disclosure;

FIG. 17 is a structural diagram of a device for sending response information according to another embodiment of the present disclosure;

FIG. 18 is a structural diagram of a device for receiving response information according to an embodiment of the present disclosure; and

FIG. 19 is a structural diagram of a device for receiving response information according to another embodiment of the present disclosure.

### DETAILED DESCRIPTION OF THE INVENTION

Embodiments of the present disclosure are further described with reference to accompanying drawings and specific implementations.

Examples will be described in detail here and shown in the accompanying drawings illustratively. When the following description involves the accompanying drawings, unless otherwise specified, an identical number in different accompanying drawings denotes identical or similar elements. Implementations described in the following examples do not denote all implementations consistent with the embodiments of the present disclosure. On the contrary, the implementations are merely instances of a device and a method consistent with some aspects of the present disclosure as detailed in the appended claims.

The terms used in the embodiments of the present disclosure are merely to describe the specific embodiments, instead of limiting the embodiments of the present disclosure. The singular forms such as “a/an,” and “the” used in the embodiments of the present disclosure and the appended claims are also intended to include the plural forms, unless otherwise clearly stated in the context. It is to be further understood that the term “and/or” used here refers to and includes any of one or more of the associated listed items or all possible combinations.

It is to be understood that although the terms such as first, second, and third may be configured to describe various information in the embodiments of the present disclosure, the information is not limited to the terms. The terms are merely configured to distinguish an identical type of information from each other. For instance, without departing from the scope of the embodiments of the present disclosure, first indication information may alternatively be referred to as second indication information. Similarly, second indication information may be referred to as first indication information. Depending on the context, the word “if” used here can be interpreted as “when” or “at the time of” or “in response to determining”.

The embodiments of the present disclosure are described in detail below, and the embodiments are illustratively shown in accompanying drawings, throughout which identical or similar reference numerals denote identical or similar elements. The embodiments described with reference to the accompanying drawings are illustrative and only intended to explain the present disclosure, instead of limiting the present disclosure.

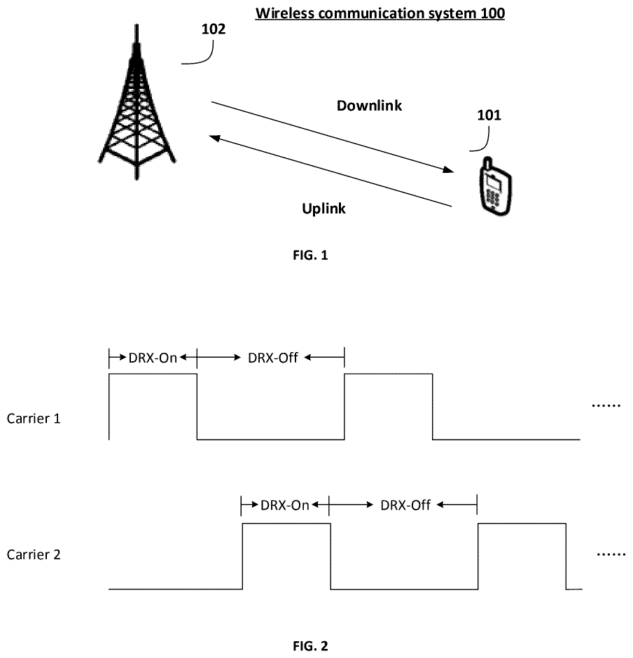

As shown in FIG. 1, a method provided by an embodiment of the present disclosure may be applied to a wireless communication system 100. The wireless communication system 100 may include user equipment 101 and a network device 102, and a number of included devices is not limited.

It is to be understood that the wireless communication system 100 may be applied to both a low-frequency scenario and a high-frequency scenario. Application scenes of the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, a future evolved public land mobile network (PLMN) system, etc.

The user equipment 101 may be a terminal, access user equipment, a user equipment unit, a user equipment station, a mobile station (MS), a remote station, remote user equipment, a mobile terminal, a wireless communication device, a user equipment agent, etc. The user equipment 101 may have a wireless transceiver function, and can be in communication (for instance, wireless communication) with one or more network devices of one or more communication systems and receive a network service provided by the network device. The network device here includes, but is not limited to, the network device 102 illustrated.

The user equipment 101 may be a cell phone, a cordless phone, a session initiation protocol (SIP) phone, a wireless local loop (WLL) station, a personal digital assistant (PDA) device, a handheld device having a wireless communication function, a computing device or other processing devices connected to a wireless modem, an on-board device, a wearable device, user equipment in a future 5G network, or user equipment in a future evolved PLMN, etc.

For instance, the network device 102 may be an access network device (or an access network site). The access network device refers to a device providing a network access function, such as a radio access network (RAN) base station. Specifically, the access network device may include a base station (BS), or a wireless resource management device including a base station and configured to control the base station. Or the access network device may include a relay station (a relay device), an access point, a base station in the future 5G network, a base station in the future evolved PLMN, an NR base station, etc. Or the access network device may be a wearable device or a vehicular device. Or the network device 102 may be a communication chip having a communication module.

When using the DRX, the network device does not receive partial uplink information in the first time period of the DRX, and normally receives uplink information in the second time period of the DRX. For instance, the partial uplink information not received in the first time period of the DRX includes a hybrid automatic repeat request acknowledgement (HARQ-ACK) sent by user equipment.

A first time period of discontinuous reception (DRX) may be referred to as a DRX-Off period, a DRX sleep period, a DRX energy-saving period, etc.

A second time period of the DRX may be referred to as a DRX-On period, a DRX non-energy-saving period, etc.

In an instance, the DRX first time period may be referred to as a third time period of DRX. The second time period of the DRX may be referred to as a fourth time period of the DRX.

In another instance, the DRX first time period may be referred to as a fifth time period of the DRX. The second time period of the DRX may be referred to as a sixth time period of the DRX.

During DRX configuration, the DRX configuration may be performed on a carrier. For instance, the DRX configuration is performed on different carriers. In an instance, as shown in FIG. 2, different DRX configuration information is configured for a carrier 1 and a carrier 2 respectively.

After DRX is configured for a carrier, in a case where a time period is in a DRX-On period on the carrier, it is said that the carrier is in a DRX-on state within the time period. Similarly, in a case where a time period is in a DRX-Off period on the carrier, it is said that the carrier is in a DRX-Off state within the time period.

In a case where a carrier is in a non-DRX-Off state in a time period, there are two cases accordingly. In a first case, the carrier is in a DRX-on state in the time period. In the second case, the carrier is not configured with DRX configuration information, or the carrier is not configured with DRX configuration information in the time period.

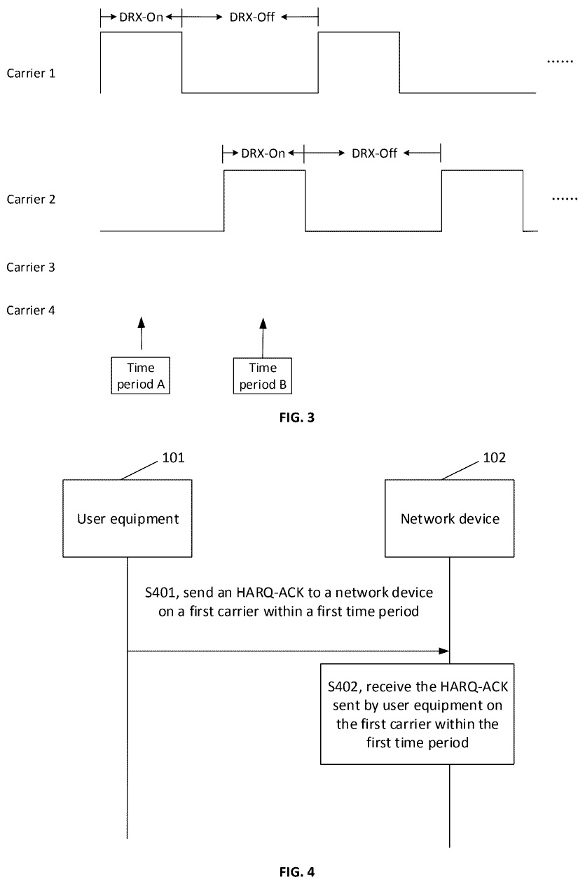

In an instance, as shown in FIG. 3, user equipment (UE) uses carrier aggregation (CA) and is configured with 4 serving carriers.

Different DRX configuration information is configured for the carrier 1 and the carrier 2 respectively. DRX configuration information is not configured for a carrier 3 and a carrier 4.

A time period A corresponds to a DRX-On period of the carrier 1 and a DRX-Off period of the carrier 2. That is, the carrier 1 is in a DRX-On state in the time period A, and the carrier 2 is in a DRX-Off state in the time period A.

A time period B corresponds to a DRX-Off period of the carrier 1 and a DRX-On period of the carrier 2. That is, the carrier 1 is in a DRX-Off state in the time period B, and the carrier 2 is in a DRX-On state in the time period B.

In some possible implementations, in a case where the UE supports a plurality of sending links (for instance, in a CA scene), not all serving cells may be configured with physical uplink control channels (PUCCHs). In an instance, a primary cell (Pcell) of a primary cell group and a primary secondary cell (PScell) of a secondary cell group are collectively referred to as special cells (spCells). The spCell is configured with a PUCCH. In a case where the UE has supporting capability, a PUCCH may be configured for at most one secondary cell of the secondary cell group, or a PUCCH may be configured for at most one secondary cell of each cell group (the primary cell group or the secondary cell group). In a case where a carrier configured to report a hybrid automatic repeat request acknowledgement (HARQ-ACK) is configured to transmit the HARQ-ACK on a PUCCH, it is necessary to ensure that the carrier is configured with the PUCCH.

Two types of physical downlink shared channels (PDSCHs) may be scheduled for the UE. A first type of PDSCH is a semi-persistent scheduling physical downlink shared channel (SPS PDSCH). A second type of PDSCH is a dynamically scheduled PDSCH (DG PDSCH). The network device configures a transmission cycle and a transmission resource of the SPS PDSCH through a higher-layer signaling, as well as some parameters of a PUCCH resource configured to feed back a corresponding HARQ-ACK. Then, the SPS PDSCH may be started after activation through downlink control information (DCI), and the network device may perform deactivation through the DCI.

For the first type of PDSCH, the UE may be configured with a function of transmitting a PUCCH on a secondary cell (Scell) or not. For UE not configured with the function, a PUCCH may only be transmitted on a primary secondary cell (PScell), such that the HARQ-ACK of the SPS PDSCH may only be reported on the primary secondary cell (PScell). That is, in a case where the SPS PDSCH is configured in the primary cell group, the HARQ-ACK is transmitted on the primary cell (Pcell) of the primary cell group. In a case where the SPS PDSCH is configured in the secondary cell group, the HARQ-ACK is transmitted on the primary cell (Pcell) of the secondary cell group. In a case where the primary secondary cell (PScell) is in a DRX-Off state, the network device cannot receive the HARQ-ACK of the SPS PDSCH fed back by the UE.

For the second type of PDSCH, it may be considered that the second type of PDSCH does not have the above problems of the first type of PDSCH. Because a dynamic PUCCH Scell switch function may be introduced, a carrier configured to feed back an HARQ-ACK may be directly indicated in scheduling DCI. Thus, the network device may flexibly indicate a carrier that is not in a DRX-Off state for the UE to report the HARQ-ACK.

Considering that for the first type of PDSCH (that is, the SPS PDSCH), the UE is configured to report the HARQ-ACK on a carrier, and the carrier is configured with DRX. In a case where the UE reports the HARQ-ACK on the carrier in a time period for reporting the HARQ-ACK and the carrier is in a DRX-Off state in the time period, the network device cannot receive the HARQ-ACK.

An embodiment of the present disclosure provides a method for sending an HARQ-ACK and a method for receiving an HARQ-ACK. FIG. 4 is a flowchart of sending and receiving an HARQ-ACK according to an example. As shown in FIG. 4, the method includes S401 to S402.

In S401, UE sends an HARQ-ACK to a network device on a first carrier within a first time period. The HARQ-ACK is configured by the network device or pre-defined by a protocol to be sent on a second carrier. The first time period is located within a third time period of discontinuous reception (DRX) of the second carrier. The first carrier is different from the second carrier.

In an instance, in S401, the UE receives configuration information sent by the network device before sending the HARQ-ACK to the network device on the first carrier within the first time period. The configuration information is configured to configure the HARQ-ACK to be sent on the second carrier. In a case where it is known that the HARQ-ACK is sent on the second carrier and the first time period is located within the third time period of discontinuous reception (DRX) of the second carrier, the UE sends the HARQ-ACK to the network device on the first carrier within the first time period.

In an instance, in S401, the UE knows that the HARQ-ACK needs to be sent on the second carrier according to a protocol before sending the HARQ-ACK to the network device on the first carrier within the first time period. In a case where it is known that the HARQ-ACK is sent on the second carrier and the first time period is located within the third time period of discontinuous reception (DRX) of the second carrier, the UE sends the HARQ-ACK to the network device on the first carrier within the first time period.

In some possible implementations, the HARQ-ACK is an HARQ-ACK corresponding to a semi-persistent scheduling physical downlink shared channel (SPS PDSCH).

In some possible implementations, the first carrier is configured with a PUCCH resource. The first carrier is at least one of the following:
a primary cell of a primary cell group;
a primary cell of a secondary cell group; or
a secondary cell configured with a PUCCH.

In some possible implementations, the first carrier is in a non-DRX-off state within the first time period. The non-DRX-off state is a DRX working state or a state where the DRX is not configured.

Or the first carrier is in a non-DRX-off state within a second time period. The second time period includes the first time period.

In some possible embodiments, the first time period may be a time period configured to send the HARQ-ACK. Or the first time period may include a time period configured to send the HARQ-ACK, and duration of the first time period is longer than duration of the time period configured to send the HARQ-ACK.

In an instance, the time period configured to send the HARQ-ACK is [t1, t2], and the first time period is [t1, t2], where t1 and t2 denote time domain moments.

In another instance, the time period configured to send the HARQ-ACK is [t1, t2], and the second time period is [t3, t4], where t3 is earlier than t1, t4 is later than t2, and t1, t2, t3 and t4 denote time domain moments.

In some possible implementations, the first carrier corresponds to the primary cell (Pcell) of the primary cell group agreed by a protocol.

In S402, the network device receives the HARQ-ACK sent by the UE on the first carrier within the first time period.

In the embodiment of the present disclosure, in a case where the network device uses the DRX, the UE is configured to send the HARQ-ACK on the first carrier different from the second carrier while sending the HARQ-ACK on the second carrier in the third time period of the DRX. Thus, a problem that the HARQ-ACK cannot be reported due to the fact that the sending time period is in the third time period of the DRX on the second carrier is solved, invalid reporting of the HARQ-ACK due to use of the DRX is avoided, and reporting validity of the HARQ-ACK when using the DRX is ensured.

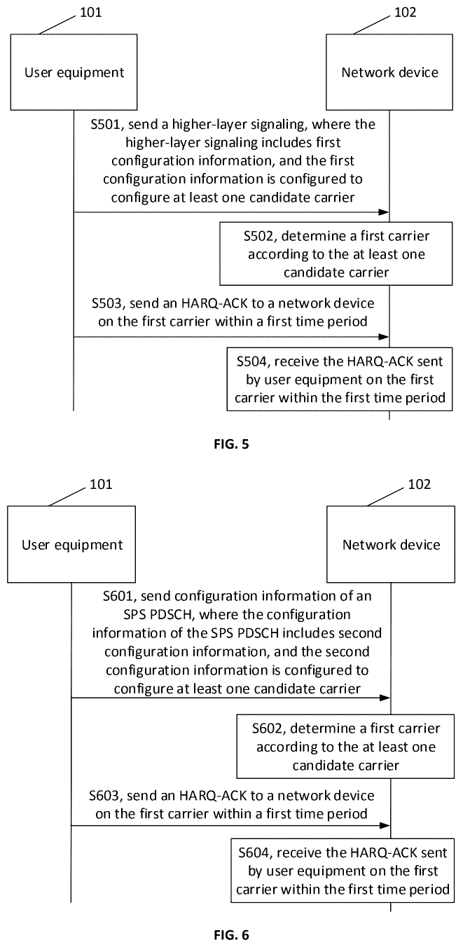

An embodiment of the present disclosure provides a method for sending an HARQ-ACK and a method for receiving an HARQ-ACK. FIG. 5 is a flowchart of sending and receiving an HARQ-ACK according to an example. As shown in FIG. 5, the method includes S501 to S504.

In S501, a network device sends a higher-layer signaling to UE. The higher-layer signaling includes first configuration information. The first configuration information is configured to configure at least one candidate carrier.

In some possible implementations, the higher-layer signaling is radio resource control (RRC) signaling or medium access control control element (MAC CE) signaling.

In S502, the UE determines a first carrier according to the at least one candidate carrier.

In some possible implementations, in a case where the at least one candidate carrier is one candidate carrier, it is determined that the first carrier is the one candidate carrier.

In some possible implementations, in a case where the at least one candidate carrier is one or more candidate carriers, the UE selects the first carrier among the one or more candidate carriers according to a rule.

Optionally, the rule includes at least one of the following:
selecting a carrier that is in a working time period of the DRX within the first time period,
selecting a carrier that is in a working time period of the DRX within the first time period and has a minimum cell index,
selecting a carrier on which the DRX is not configured, or
selecting a carrier on which the DRX is not configured and has the minimum cell index.

Selection of the carrier that has the minimum cell index is conducive to selection of a primary cell.

In some possible implementations, in a case where the at least one candidate carrier is one or more candidate carriers, one or more carriers satisfying a condition are selected among the one or more candidate carriers, and the first carrier is selected among the one or more carriers according to a rule.

The condition includes one of the following:
being configured with a PUCCH resource; or
being in a non-DRX-off state in a sending time period of the HARQ-ACK, where the non-DRX-off state is a DRX working state or a state where the DRX is not configured.

The rule is identical to the rule in the previous implementation, and will not be repeated here.

In S503, the UE sends the HARQ-ACK to the network device on the first carrier within the first time period. The HARQ-ACK is configured by the network device or pre-defined by a protocol to be sent on a second carrier. The first time period is located within a third time period of discontinuous reception (DRX) of the second carrier. The first carrier is different from the second carrier.

In S504, the network device receives the HARQ-ACK sent by the UE on the first carrier within the first time period.

In the embodiment of the present disclosure, the network device configures the at least one candidate carrier for the UE through the higher-layer signaling, and the UE determines an appropriate first carrier on which the HARQ-ACK is sent to the network device within the first time period from the candidate carriers. Thus, a problem that the HARQ-ACK cannot be reported due to the fact that the sending time period configured to send the HARQ-ACK is in the third time period of the DRX on the second carrier is solved.

In an instance, assuming that an SPS PDSCH is configured in a secondary cell group and a base station does not configure a PUCCH cell switch characteristic for the UE, an HARQ-ACK of the SPS PDSCH is sent on a primary cell (Pcell) of the secondary cell group. The primary cell (Pcell) of the secondary cell group is marked as a cell A. In a case where a DRX function is configured on the PScell, the UE reports the HARQ-ACK of the SPS PDSCH in a DRX-Off state of the cell A, and the network device cannot receive the HARQ-ACK.

The network device sends the higher-layer signaling to the UE. The higher-layer signaling includes the first configuration information. The first configuration information is configured to configure 2 candidate carriers. Each of the 2 candidate carriers is configured with a PUCCH. One of the 2 candidate carriers is a primary cell (marked as a cell B) of a primary cell group. The cell B is not configured with the DRX function. The other candidate carrier is one Scell (marked as a cell C) configured with the PUCCH resource in the primary cell group. The cell C is configured with the DRX function. However, the cell C is not in a DRX-Off state in a time period for reporting the HARQ-ACK of the SPS PDSCH.

The UE determines one first carrier according to a preset rule, and for instance, preferably selects the cell B.

An embodiment of the present disclosure provides a method for sending an HARQ-ACK and a method for receiving an HARQ-ACK. FIG. 6 is a flowchart of sending and receiving an HARQ-ACK according to an example. As shown in FIG. 6, the method includes S601 to S604.

In S601, a network device sends configuration information of an SPS PDSCH to UE. The configuration information of the SPS PDSCH includes second configuration information. The second configuration information is configured to configure at least one candidate carrier.

In some possible implementations, the first carrier is one of the at least one candidate carrier.

In S602, the UE determines the first carrier according to the at least one candidate carrier.

In some possible implementations, in a case where the at least one candidate carrier is one candidate carrier, it is determined that the first carrier is the one candidate carrier.

In some possible implementations, in a case where the at least one candidate carrier is one or more candidate carriers, the UE selects the first carrier among the one or more candidate carriers according to a rule.

Optionally, the rule includes at least one of the following:
selecting a carrier that is in a working time period of the DRX within the first time period,
selecting a carrier that is in a working time period of the DRX within the first time period and has a minimum cell index,
selecting a carrier on which the DRX is not configured, or
selecting a carrier on which the DRX is not configured and has the minimum cell index.

Selection of the carrier that has a minimum cell index is conducive to selection of a primary cell.

In some possible implementations, in a case where the at least one candidate carrier is one or more candidate carriers, one or more carriers satisfying a condition are selected among the one or more candidate carriers, and the first carrier is selected among the one or more carriers according to a rule.

The condition includes one of the following:
being configured with a PUCCH resource; or
being in a non-DRX-off state in a sending time period of the HARQ-ACK, where the non-DRX-off state is a DRX working state or a state where the DRX is not configured.

The rule is identical to the rule in the previous implementation, and will not be repeated here.

In S603, the UE sends the HARQ-ACK to the network device on the first carrier within the first time period. The HARQ-ACK is configured by the network device or pre-defined by a protocol to be sent on a second carrier. The first time period is located within a third time period of discontinuous reception (DRX) of the second carrier. The first carrier is different from the second carrier.

In S604, the network device receives the HARQ-ACK sent by the UE on the first carrier within the first time period.

In the embodiment of the present disclosure, the network device configures the at least one candidate carrier for the UE through the configuration information of the SPS PDSCH, and the UE determines an appropriate first carrier on which the HARQ-ACK is sent to the network device within the first time period from the candidate carriers. Thus, a problem that the HARQ-ACK cannot be reported due to the fact that the sending time period configured to send the HARQ-ACK is in the third time period of the DRX on the second carrier is solved.

In an instance, assuming that an SPS PDSCH is configured in a secondary cell group and a base station does not configure a PUCCH cell switch characteristic for the UE, an HARQ-ACK of the SPS PDSCH is sent on a primary cell (Pcell) of the secondary cell group. The primary cell (Pcell) of the secondary cell group is marked as a cell A. In a case where a DRX function is configured on a PScell, the UE reports the HARQ-ACK of the SPS PDSCH in a DRX-Off state of the cell A, and the network device cannot receive the HARQ-ACK.

The network device sends the configuration information of the SPS PDSCH to the UE. The configuration information of the SPS PDSCH includes first configuration information. The first configuration information is configured to configure 2 candidate carriers. Each of the 2 candidate carriers is configured with a PUCCH. One of the 2 candidate carriers is a primary cell (marked as a cell B) of a primary cell group. The cell B is not configured with the DRX function. The other candidate carrier is one Scell (marked as a cell C) configured with the PUCCH resource in the primary cell group. The cell C is configured with the DRX function. However, the cell C is not in a DRX-Off state in a time period for reporting the HARQ-ACK of the SPS PDSCH.

The UE determines one first carrier according to a preset rule, and for instance, preferably selects the cell B.

An embodiment of the present disclosure provides a method for sending an HARQ-ACK and a method for receiving an HARQ-ACK. FIG. 7 is a flowchart of sending and receiving an HARQ-ACK according to an example. As shown in FIG. 7, the method includes S701 to S703.

In S701, UE selects one activated carrier satisfying a condition as a first carrier among activated carriers of the UE.

The condition includes one of the following:
being configured with a PUCCH resource; or
being in a non-DRX-off state in a sending time period of the HARQ-ACK, where the non-DRX-off state is a DRX working state or a state where the DRX is not configured.

In S702, the UE sends the HARQ-ACK to a network device on the first carrier within a first time period. The HARQ-ACK is configured by the network device or pre-defined by a protocol to be sent on a second carrier. The first time period is located within a third time period of discontinuous reception (DRX) of the second carrier. The first carrier is different from the second carrier.

In S703, the network device receives the HARQ-ACK sent by the UE on the first carrier within the first time period.

In the embodiment of the present disclosure, the UE determines an appropriate first carrier on which the HARQ-ACK is sent to the network device within the first time period among the activated carriers of the UE without indication of the network device, such that signaling overhead can be saved.

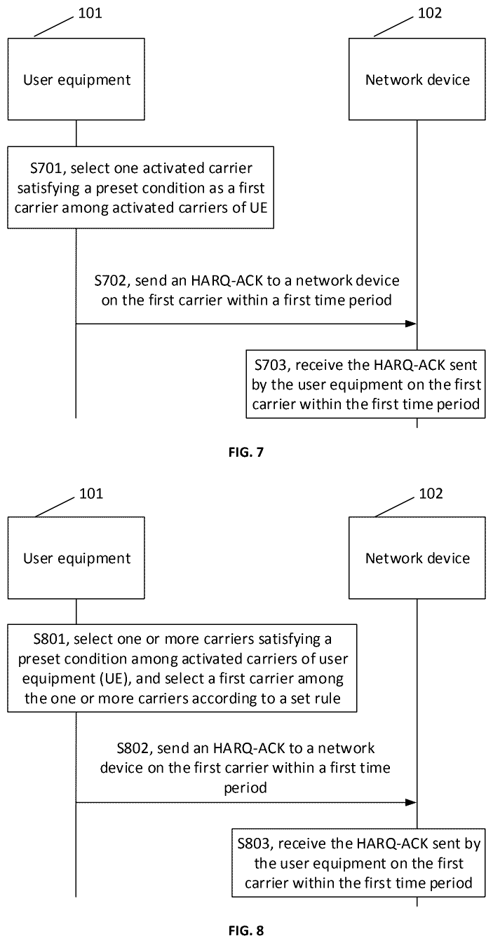

An embodiment of the present disclosure provides a method for sending an HARQ-ACK and a method for receiving an HARQ-ACK. FIG. 8 is a flowchart of sending and receiving an HARQ-ACK according to an example. As shown in FIG. 8, the method includes S801 to S803.

In S801, one or more carriers satisfying a condition are selected among activated carriers of user equipment, and a first carrier is selected among the one or more carriers according to a rule.

The condition includes one of the following:
being configured with a PUCCH resource; or
being in a non-DRX-off state in a sending time period of the HARQ-ACK, where the non-DRX-off state is a DRX working state or a state where the DRX is not configured.

Optionally, the rule includes at least one of the following:
selecting a carrier that is in a working time period of the DRX within the first time period,
selecting a carrier that is in a working time period of the DRX within the first time period and has a minimum cell index,
selecting a carrier on which the DRX is not configured, or
selecting a carrier on which the DRX is not configured and has the minimum cell index.

Selection of the carrier that has a minimum cell index is conducive to selection of a primary cell.

In S802, the user equipment (UE) sends the HARQ-ACK to a network device on the first carrier within the first time period. The HARQ-ACK is configured by the network device or pre-defined by a protocol to be sent on a second carrier. The first time period is located within a third time period of discontinuous reception (DRX) of the second carrier. The first carrier is different from the second carrier.

In S803, the network device receives the HARQ-ACK sent by the UE on the first carrier within the first time period.

In the embodiment of the present disclosure, the UE determines an appropriate first carrier on which the HARQ-ACK is sent to the network device within the first time period among the activated carriers of the UE without indication of the network device, such that signaling overhead can be saved.

In an instance, assuming that an SPS PDSCH is configured in a secondary cell group and a base station does not configure a PUCCH cell switch characteristic for the UE, an HARQ-ACK of the SPS PDSCH is sent on a primary cell (Pcell) of the secondary cell group. The primary cell (Pcell) of the secondary cell group is marked as a cell A. In a case where a DRX function is configured on a PScell, the UE reports the HARQ-ACK of the SPS PDSCH in a DRX-Off state of the cell A, and the network device cannot receive the HARQ-ACK.

The network device configures 5 serving carriers for the UE, which include 4 activated serving carriers. The 4 activated serving carriers include the cell A, a primary cell of a primary cell group which is marked as a cell B, one Scell of the primary cell group which is marked as a cell C, and another Scell of the primary cell group which is marked as a cell D. The cell B and the cell C are configured with PUCCHs. The cell C is not configured with the DRX function. The cell D is configured with the DRX function. However, the cell D is not in a DRX-Off state in a time period for reporting the HARQ-ACK of the SPS PDSCH.

The UE selects the cell C and the cell D among the 4 activated serving carriers according to the condition.

The UE selects the cell C among the cell C and the cell D according to the rule.

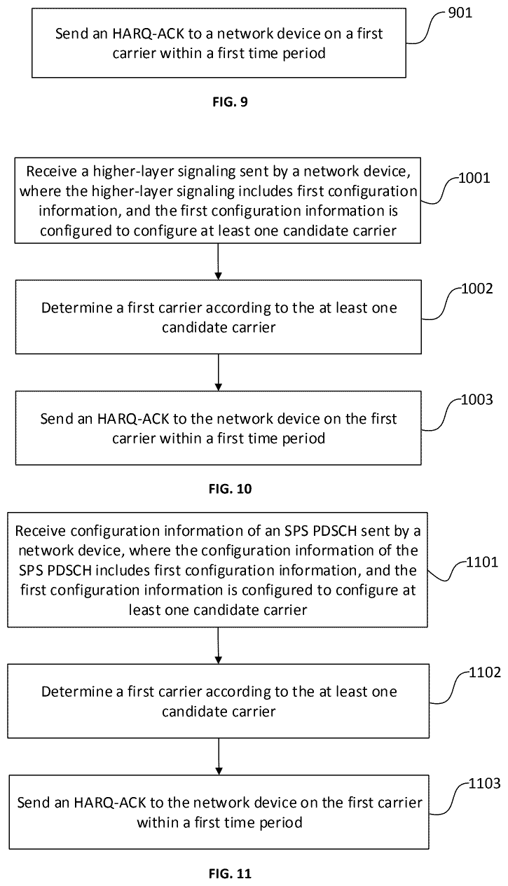

An embodiment of the present disclosure provides a method for sending response information. The method is performed by user equipment. FIG. 9 is a flowchart of sending response information according to an example. As shown in FIG. 9, the method includes S901.

In S901, an HARQ-ACK is sent to a network device on a first carrier within a first time period. The HARQ-ACK is configured by the network device or pre-defined by a protocol to be sent on a second carrier. The first time period is located within a third time period of discontinuous reception (DRX) of the second carrier. The first carrier is different from the second carrier.

The content in S901 is identical to that in S401, and reference is made to S401, which will not be repeated here.

An embodiment of the present disclosure provides a method for sending response information. The method is performed by user equipment. FIG. 10 is a flowchart of sending response information according to an example. As shown in FIG. 10, the method includes S1001 to S1003.

In S1001, a higher-layer signaling sent by a network device is received. The higher-layer signaling includes first configuration information. The first configuration information is configured to configure at least one candidate carrier.

In S1002, a first carrier is determined according to the at least one candidate carrier.

The content in S1002 is identical to that in S502, and reference is made to S502, which will not be repeated here.

In S1003, an HARQ-ACK is sent to the network device on the first carrier within a first time period. The HARQ-ACK is configured by the network device or pre-defined by a protocol to be sent on a second carrier. The first time period is located within a third time period of discontinuous reception (DRX) of the second carrier. The first carrier is different from the second carrier.

An embodiment of the present disclosure provides a method for sending response information. The method is performed by user equipment. FIG. 11 is a flowchart of sending response information according to an example. As shown in FIG. 11, the method includes S1101 to S1103.

In S1101, configuration information of an SPS PDSCH sent by a network device is received. The configuration information of the SPS PDSCH includes second configuration information. The second configuration information is configured to configure at least one candidate carrier.

In some possible implementations, a first carrier is one candidate carrier among the at least one candidate carrier.

In S1102, a first carrier is determined according to the at least one candidate carrier.

The content in S1102 is identical to that in S602, and reference is made to S602, which will not be repeated here.

In S1103, an HARQ-ACK is sent to the network device on the first carrier within a first time period. The HARQ-ACK is configured by the network device or pre-defined by a protocol to be sent on a second carrier. The first time period is located within a third time period of discontinuous reception (DRX) of the second carrier. The first carrier is different from the second carrier.

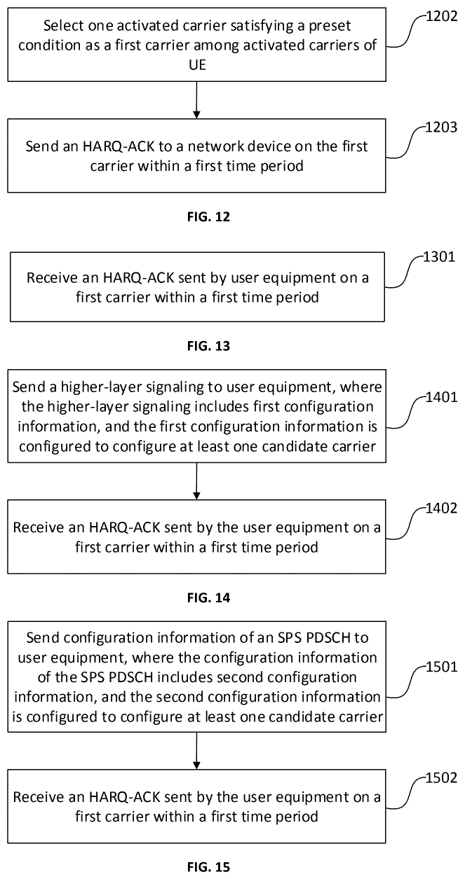

An embodiment of the present disclosure provides a method for sending response information. The method is performed by user equipment. FIG. 12 is a flowchart of sending response information according to an example. As shown in FIG. 12, the method includes S1202 to S1203.

In S1202, one activated carrier satisfying a condition is selected as a first carrier among activated carriers of the user equipment (UE).

The content in S1202 is identical to that in S701, and reference is made to S701, which will not be repeated here.

In S1203, an HARQ-ACK is sent to a network device on the first carrier within a first time period. The HARQ-ACK is configured by the network device or pre-defined by a protocol to be sent on a second carrier. The first time period is located within a third time period of discontinuous reception (DRX) of the second carrier. The first carrier is different from the second carrier.

An embodiment of the present disclosure provides a method for receiving response information. The method is performed by a network device. FIG. 13 is a flowchart of receiving response information according to an example. As shown in FIG. 13, the method includes S1301.

In S1301, an HARQ-ACK sent by UE is received on a first carrier within a first time period. The HARQ-ACK is configured by a network device or pre-defined by a protocol to be sent on a second carrier. The first time period is located within a third time period of discontinuous reception (DRX) of the second carrier. The first carrier is different from the second carrier.

The content in S1301 is identical to that in S402, and reference is made to S402, which will not be repeated here.

An embodiment of the present disclosure provides a method for receiving response information. The method is performed by a network device. FIG. 14 is a flowchart of receiving response information according to an example. As shown in FIG. 14, the method includes S1401 to S1402.

In S1401, a higher-layer signaling is sent to UE. The higher-layer signaling includes first configuration information. The first configuration information is configured to configure at least one candidate carrier.

In S1402, an HARQ-ACK sent by the UE is received on a first carrier within a first time period. The HARQ-ACK is configured by a network device or pre-defined by a protocol to be sent on a second carrier. The first time period is located within a third time period of discontinuous reception (DRX) of the second carrier. The first carrier is different from the second carrier.

An embodiment of the present disclosure provides a method for receiving response information. The method is performed by a network device. FIG. 15 is a flowchart of receiving response information according to an example. As shown in FIG. 15, the method includes S1501 to S1502.

In S1501, configuration information of an SPS PDSCH is sent to UE. The configuration information of the SPS PDSCH includes second configuration information. The second configuration information is configured to configure at least one candidate carrier.

In S1502, an HARQ-ACK sent by the UE is received on a first carrier within a first time period. The HARQ-ACK is configured by a network device or pre-defined by a protocol to be sent on a second carrier. The first time period is located within a third time period of discontinuous reception (DRX) of the second carrier. The first carrier is different from the second carrier.

According to an identical concept to the above method embodiment, an embodiment of the present disclosure further provides an electronic device. The electronic device may have functions of user equipment in the above method embodiment, and is configured to perform steps performed by the user equipment according to the above embodiment. The functions may be achieved by hardware or software, or by performing corresponding software with hardware. The hardware or software includes one or more modules corresponding to the above functions.

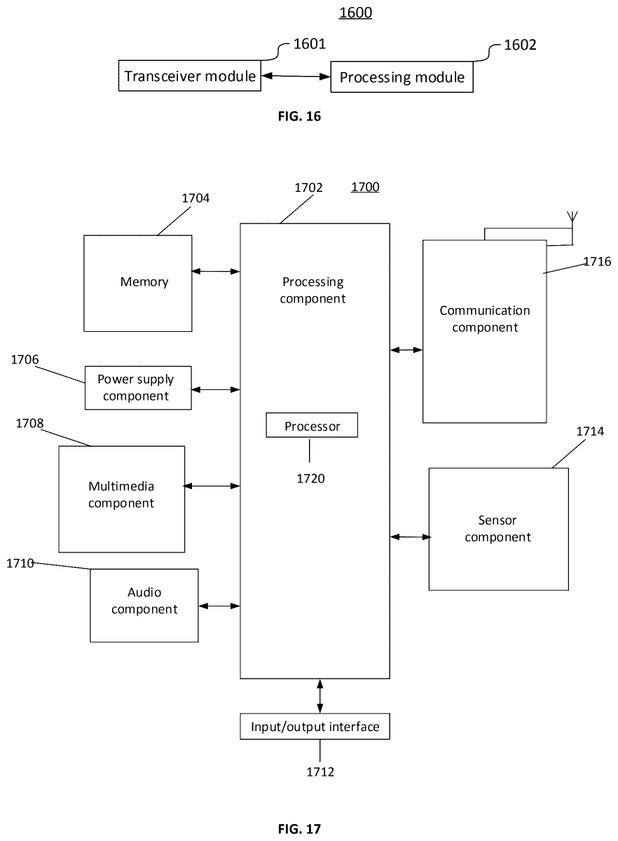

In a possible implementation, an electronic device 1600 shown in FIG. 16 may be used as user equipment involved in the above method embodiment, and perform the steps performed by the user equipment in the above method embodiment.

The electronic device 1600 includes a transceiver module 1601 and a processing module 1602.

The transceiver module 1601 is configured to send a hybrid automatic repeat request acknowledgement (HARQ-ACK) to a network device on a first carrier within a first time period. The HARQ-ACK is configured by the network device or pre-defined by a protocol to be sent on a second carrier. The first time period is located within a third time period of discontinuous reception (DRX) of the second carrier. The first carrier is different from the second carrier.

In some possible implementations, the HARQ-ACK is an HARQ-ACK corresponding to a semi-persistent scheduling physical downlink shared channel (SPS PDSCH).

In some possible implementations, the first carrier is configured with a PUCCH resource. The first carrier is at least one of the following:
a primary cell of a primary cell group;
a primary cell of a secondary cell group; or
a secondary cell configured with a PUCCH.

In some possible implementations, the transceiver module 1601 is further configured to receive a higher-layer signaling sent by the network device. The higher-layer signaling includes first configuration information. The first configuration information is configured to configure at least one candidate carrier. The first carrier is one candidate carrier among the at least one candidate carrier.

In some possible implementations, the transceiver module 1601 is further configured to receive configuration information of the SPS PDSCH sent by the network device. The configuration information of the SPS PDSCH includes second configuration information. The second configuration information is configured to configure at least one candidate carrier. The first carrier is one of the at least one candidate carrier.

In some possible implementations, the processing module 1602 is further configured to select one carrier satisfying a condition as the first carrier among the one or more candidate carriers, or select one or more carriers satisfying a condition among the one or more candidate carriers, and select the first carrier among the one or more carriers according to a rule.

In some possible implementations, the processing module 1602 is further configured to select one carrier satisfying a condition as the first carrier among activated carriers of the user equipment, or select one or more carriers satisfying a condition among the activated carriers of the user equipment, and select the first carrier among the one or more carriers according to a rule.

In some possible implementations, the condition includes one of the following:
being configured with a PUCCH resource; or
being in a non-DRX-off state in a sending time period of the HARQ-ACK, where the non-DRX-off state is a DRX working state or a state where the DRX is not configured.

In some possible implementations, the rule includes at least one of the following:
selecting a carrier that is in a working time period of the DRX within the first time period;
selecting a carrier that is in a working time period of the DRX within the first time period and has a minimum cell index;
selecting a carrier on which the DRX is not configured; or
selecting a carrier on which the DRX is not configured and has the minimum cell index.

In some possible implementations, the first carrier corresponds to a primary cell of a primary cell group agreed by a protocol.

A structure of user equipment 101 may be as shown in FIG. 17. FIG. 17 is a block diagram of a device 1700 for sending an HARQ-ACK according to one example. For instance, the device 1700 may be a mobile phone, a computer, a digital broadcast terminal, a messaging device, a game console, a tablet device, a medical device, a fitness device, a personal digital assistant, etc.

With reference to FIG. 17, the device 1700 may include one or more of the following components: a processing component 1702, a memory 1704, a power component 1706, a multimedia component 1708, an audio component 1710, an input/output (I/O) interface 1712, a sensor component 1714, and a communication component 1716.

The processing component 1702 generally controls all operations of the device 1700, such as operations associated with display, telephone call, data communication, camera operation and recording operation. The processing component 1702 may include one or more processors 1720 for executing instructions, so as to complete all or some steps of the method. In addition, the processing component 1702 may include one or more modules to facilitate interaction between the processing component 1702 and other components. For instance, the processing component 1702 may include a multimedia module to facilitate interaction between the multimedia component 1708 and the processing component 1702.

The memory 1704 is configured to store various types of data to support the operations on the device 1700. Instances of the data include instructions for any application or method operating on the device 1700, contact data, phone book data, a message, a picture, a video, etc. The memory 1704 may be implemented by any type of volatile or nonvolatile memory device or their combinations, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk, or an optical disk.

The power component 1706 supplies power to various assemblies of the device 1700. The power component 1706 may include a power management system, one or more power supplies, and other components associated with generating, managing and distributing power for the device 1700.

The multimedia component 1708 includes a screen that provides an output interface between the device 1700 and a user. In some embodiments, the screen may include a liquid crystal display (LCD) and a touch panel (TP). In a case where the screen includes the touch panel, the screen may be implemented as a touch screen to receive an input signal from the user. The touch panel includes one or more touch sensors to sense touch, slide and gestures on the touch panel. The touch sensor may sense a boundary of a touch or slide operation, and detect duration and pressure related to the touch or slide operation. In some embodiments, the multimedia component 1708 includes a front-facing camera and/or a rear-facing camera. In a case where the device 1700 is in an operation mode, such as a photographing mode or a video mode, the front-facing camera and/or the rear-facing camera are/is capable of receiving external multimedia data. Each of the front-facing camera and the rear-facing camera may be a fixed optical lens system or have a focal length and an optical zoom capability.

The audio component 1710 is configured to output and/or input an audio signal. For instance, the audio component 1710 includes a microphone (MIC). The microphone is configured to receive an external audio signal in a case where the device 1700 is in operation modes such as a call mode, a recording mode and a speech identification mode. The received audio signal may be further stored in the memory 1704 or sent via the communication component 1716. In some embodiments, the audio component 1710 further includes a speaker configured to output an audio signal.

The I/O interface 1712 provides an interface between the processing component 1702 and a peripheral interface module. The peripheral interface module may be a keyboard, a click wheel, a button, etc. The buttons may include, but are not limited to, a home button, a volume button, a start button, and a lock button.

The sensor component 1714 includes one or more sensors configured to provide various aspects of state assessment for the device 1700. For instance, the sensor component 1714 may detect an on/off state of the device 1700 and relative positioning of the components such as a display and a keypad of the device 1700, and the sensor component 1714 may further detect position change of the device 1700 or one component of the device 1700, presence or absence of contact between the user and the device 1700, an orientation or acceleration/deceleration of the device 1700, and temperature change of the device 1700. The sensor component 1714 may include a proximity sensor configured to detect presence of a nearby object without any physical contact. The sensor component 1714 may further include an optical sensor, such as a complementary metal-oxide-semiconductor (CMOS) or charge-coupled device (CCD) image sensor, which is used in an imaging application. In some embodiments, the sensor component 1714 may further include an acceleration sensor, a gyroscope sensor, a magnetic sensor, a pressure sensor, or a temperature sensor.

The communication component 1716 is configured to facilitate wired or wireless communication between the device 1700 and other devices. The device 1700 may access a wireless network based on a communication standard, such as wireless fidelity (WiFi), the 4th generation mobile communication technology (4G) or the 5th generation mobile communication technology (5G), or their combinations. In one example, the communication component 1716 receives a broadcast signal or broadcast related information from an external broadcast management system via a broadcast channel. In one example, the communication component 1716 further includes a near field communication (NFC) module to facilitate short-range communication. For instance, the NFC module may be implemented based on a radio frequency identification (RFID) technology, an infrared data association (IrDA) technology, an ultra-wideband (UWB) technology, a Bluetooth (BT) technology or other technologies.

In an example, the device 1700 may be implemented by one or more of an application specific integrated circuit (ASIC), a digital signal processor (DSP), a digital signal processing device (DSPD), a programmable logic device (PLD), a field programmable gate array (FPGA), a controller, a microcontroller, a microprocessor or other electronic components, thus performing the method.

An example further provides a non-transitory computer-readable storage medium including instructions, such as the memory 1704 including instructions. The instructions may be executed by the processor 1720 of the device 1700 to complete the method. For instance, the non-transitory computer-readable storage medium may be an ROM, a random access memory (RAM), a compact disc-read only memory (CD-ROM), a magnetic tape, a floppy disk, an optical data storage device, etc.

According to an identical concept to the above method embodiment, an embodiment of the present disclosure further provides an electronic device. The electronic device may have functions of the network device in the above method embodiment, and is configured to perform the steps performed by the network device according to the above embodiment. The functions may be achieved by hardware or software, or by performing corresponding software with hardware. The hardware or software includes one or more modules corresponding to the above functions.

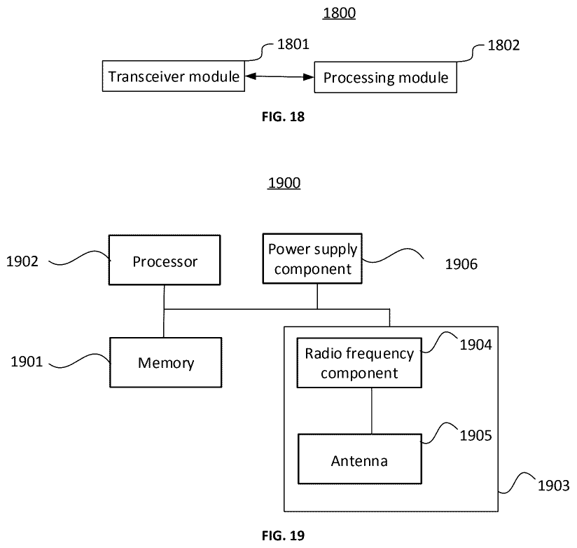

In a possible implementation, an electronic device 1800 shown in FIG. 18 may be used as the network device involved in the above method embodiment, and perform steps performed by the network device in the above method embodiment.

The electronic device 1800 includes a transceiver module 1801 and a processing module 1802.

The transceiver module 1801 is configured to receive a hybrid automatic repeat request acknowledgement (HARQ-ACK) sent by user equipment on a first carrier within a first time period. The HARQ-ACK is configured by the network device or pre-defined by a protocol to be sent on a second carrier. The first time period is located within a third time period of discontinuous reception (DRX) of the second carrier. The first carrier is different from the second carrier.

In some possible implementations, the HARQ-ACK is an HARQ-ACK corresponding to a semi-persistent scheduling physical downlink shared channel (SPS PDSCH).

In some possible implementations, the first carrier is configured with a PUCCH resource. The first carrier is at least one of the following:
a primary cell of a primary cell group;
a primary cell of a secondary cell group; or
a secondary cell configured with a PUCCH.

In some possible implementations, the transceiver module 1801 is further configured to send a higher-layer signaling to the user equipment. The higher-layer signaling includes first configuration information. The first configuration information is configured to configure at least one candidate carrier. The first carrier is one of the at least one candidate carrier.

In some possible implementations, the transceiver module 1801 is further configured to send configuration information of the SPS PDSCH to the user equipment. The configuration information of the SPS PDSCH includes second configuration information. The second configuration information is configured to configure at least one candidate carrier. The first carrier is one of the at least one candidate carrier.

In some possible implementations, the first carrier corresponds to a primary cell of a primary cell group agreed by a protocol.

A structure of the network device may be shown in FIG. 19. As shown in FIG. 19, a device 1900 includes a memory 1901, a processor 1902, a transceiver component 1903, and a power supply component 1906. The memory 1901 is coupled to the processor 1902 and may be configured to store programs and data necessary for the communication device 1900 to achieve all functions. The processor 1902 is configured to support the communication device 1900 in achieving a corresponding function in the above method. The function may be achieved by invoking the programs stored in the memory 1901. The transceiver component 1903 may be a wireless transceiver, and may be configured to support the communication device 1900 in receiving signaling and/or data and sending signaling and/or data through radio. The transceiver component 1903 may be referred to as a transceiver unit or a communication unit. The transceiver component 1903 may include a radio frequency component 1904 and one or more antennas 1905. The radio frequency component 1904 may be a remote radio unit (RRU), and specifically, may be configured for transmission of radio frequency signals and conversion between radio frequency signals and baseband signals. Specifically, the one or more antennas 1905 may be configured for radiation and reception of radio frequency signals.

In a case where the communication device 1900 needs to send data, the processor 1902 may perform baseband processing on to-be-sent data, and then output a baseband signal to a radio unit. The radio unit performs radio frequency processing on the baseband signal and then sends the radio frequency signal in a form of electromagnetic waves through the antenna. In a case where data is sent to the communication device 1900, the radio unit receives the radio frequency signal through the antenna, converts the radio frequency signal into the baseband signal, and outputs the baseband signal to the processor 1902. The processor 1902 converts the baseband signal into data and processes the data.

An embodiment of the present disclosure provides a computer-readable storage medium. The computer-readable storage medium stores instructions. The instructions, when invoked and executed in a computer, cause the computer to perform the above method for sending response information or the above method for receiving response information.

As used herein, the term processor may refer to one processor that performs the defined functions or a plurality of processors that collectively perform defined functions, so that the execution of the individual defined functions may be divided amongst such processors.

Those skilled in the art could easily conceive of other implementation solutions of the embodiments of the present disclosure upon consideration of the description and the invention disclosed here. The present disclosure is intended to cover any variations, uses or adaptive changes of the embodiments of the present disclosure. The variations, uses or adaptive changes follow the general principles of the embodiments of the present disclosure and include common general knowledge or conventional technical means in the technical field not disclosed in the present disclosure. The description and the embodiments are regarded as merely illustrative, and the true scope and spirit of the embodiments of the present disclosure are indicated by the following claims.

It is to be understood that the embodiments of the present disclosure are not limited to the precise structure described above and illustrated in the accompanying drawings, and can have various modifications and changes without departing from the scope. The scope of the embodiments of the present disclosure is limited merely by the appended claims.

### INDUSTRIAL APPLICABILITY

Invalid reporting of a hybrid automatic repeat request acknowledgement (HARQ-ACK) due to the use of discontinuous reception (DRX) can be avoided, and reporting validity of the HARQ-ACK when using the DRX can be ensured.

1. A method for sending response information, performed by user equipment, the method comprising:
sending a hybrid automatic repeat request acknowledgement (HARQ-ACK) to a network device on a first carrier within a first time period, wherein the HARQ-ACK is configured by the network device or pre-defined by a protocol to be sent on a second carrier, the first time period is located within a third time period of discontinuous reception (DRX) of the second carrier, and the first carrier is different from the second carrier.

2. The method according to claim 1, wherein the HARQ-ACK is an HARQ-ACK corresponding to a semi-persistent scheduling physical downlink shared channel (SPS PDSCH).

3. The method according to claim 1, wherein the first carrier is configured with a physical uplink control channel (PUCCH) resource, and the first carrier is at least one of the following:
a primary cell of a primary cell group;
a primary cell of a secondary cell group; or
a secondary cell configured with a PUCCH.

4. The method according to claim 1, further comprising:
receiving a higher-layer signaling sent by the network device, wherein the higher-layer signaling comprises first configuration information, the first configuration information is configured to configure at least one candidate carrier, and the first carrier is one of the at least one candidate carrier.

5. The method according to claim 1, further comprising:
receiving configuration information of a semi-persistent scheduling physical downlink shared channel (SPS PDSCH) sent by the network device, wherein the configuration information of the SPS PDSCH comprises second configuration information, the second configuration information is configured to configure at least one candidate carrier, and the first carrier is one of the at least one candidate carrier.

6. The method according to claim 4, further comprising:
selecting one carrier satisfying a condition as the first carrier among the at least one candidate carrier or
selecting one or more carriers satisfying the condition among the at least one candidate carrier, and selecting the first carrier among the one or more carriers according to a rule.

7. The method according to claim 1, further comprising:
selecting one carrier satisfying a condition as the first carrier among activated carriers of the user equipment; or
selecting one or more carriers satisfying the condition among the activated carriers of the user equipment, and selecting the first carrier among the one or more carriers according to a rule.

8. The method according to claim 6, wherein the condition comprises one of the following:
being configured with a PUCCH resource; or
being in a non-DRX-off state in a sending time period of the HARQ-ACK, wherein the non-DRX-off state is a DRX working state or a state where the DRX is not configured.

9. The method according to claim 6, wherein the rule comprises at least one of the following:
selecting a carrier that is in a working time period of the DRX within the first time period;
selecting a carrier that is in a working time period of the DRX within the first time period and has a minimum cell index;
selecting a carrier on which the DRX is not configured; or
selecting a carrier on which the DRX is not configured and has the minimum cell index.

10. The method according to claim 1, wherein the first carrier corresponds to a primary cell of a primary cell group agreed by a protocol.

11. A method for receiving response information, performed by a network device, the method comprising:
receiving a hybrid automatic repeat request acknowledgement (HARQ-ACK) sent by user equipment on a first carrier within a first time period, wherein the HARQ-ACK is configured by the network device or pre-defined by a protocol to be sent on a second carrier, the first time period is located within a third time period of discontinuous reception (DRX) of the second carrier, and the first carrier is different from the second carrier.

12. The method according to claim 11, wherein the HARQ-ACK is an HARQ-ACK corresponding to a semi-persistent scheduling physical downlink shared channel (SPS PDSCH).

13. The method according to claim 12, wherein the first carrier is configured with a PUCCH resource, and the first carrier is at least one of the following:
a primary cell of a primary cell group;
a primary cell of a secondary cell group; or
a secondary cell configured with a PUCCH.

14. The method according to claim 11, further comprising:
sending a higher-layer signaling to the user equipment, wherein the higher-layer signaling comprises first configuration information, the first configuration information is configured to configure at least one candidate carrier, and the first carrier is one of the at least one candidate carrier.

15. The method according to claim 11, further comprising:
sending configuration information of an SPS PDSCH to the user equipment, wherein the configuration information of the SPS PDSCH comprises second configuration information, the second configuration information is configured to configure at least one candidate carrier, and the first carrier is one of the at least one candidate carrier.

16. The method according to claim 11, wherein the first carrier corresponds to a primary cell of a primary cell group agreed by a protocol.

17-18. (canceled)

19. An electronic device, comprising:
one or more processors; and
a memory, wherein
the memory is configured to store a computer program; and the one or more processors are collectively configured to execute the computer program to:
send a hybrid automatic repeat request acknowledgement (HARQ-ACK) to a network device on a first carrier within a first time period, wherein the HARQ-ACK is configured by the network device or pre-defined by a protocol to be sent on a second carrier, the first time period is located within a third time period of discontinuous reception (DRX) of the second carrier, and the first carrier is different from the second carrier.

20. An electronic device, comprising:
one or more processors; and
a memory, wherein the memory is configured to store a computer program; and the one or more processors are collectively configured to execute the computer program to implement the method according to claim 11.

21. A non-transitory computer-readable storage medium storing instructions, wherein the instructions, when invoked and executed in a computer, cause the computer to perform the method according to claim 1.

22. A non-transitory_computer-readable storage medium storing instructions, wherein the instructions, when invoked and executed in a computer, cause the computer to perform the method according to claim 11.
